(19) United States
(12) Patent Application Publication
(10) Pub. No.: US 2007/0051125 A1
(43) Pub. Date: Mar. 8, 2007

(54) Portable apparatus for chilling draught beverages

(75) Inventors: Sam Chiusolo, Port Perry (CA); Markus Hess, Thornhill (CA)

Correspondence Address: DIMOCK STRATTON LLP, 20 QUEEN STREET WEST SUITE 3202, BOX 102, TORONTO, ON, M5H 3R3, CA

(73) Assignee: Icefloe Technologies Inc., Mississauga, Ontario (CA)

(21) Appl. No.: 10/546,438

(22) PCT Filed: Mar. 24, 2005
(86) PCT No.: PCT/CA05/00451

§ 371 Date: Aug. 4, 2006

(30) Foreign Application Priority Data
Dec. 9, 2004 (CA) 2,489,487

(51) Int. Cl. B67D 5/62

(52) U.S. Cl. 62/393; 62/398; 62/399

(57) ABSTRACT

An apparatus and method for dispensing a liquid stored in a container is provided. The apparatus has a housing defining an inner chamber for holding a quantity of a coolant fluid. The housing also has an outer chamber that surrounds the inner chamber. The two chambers are separated by a barrier. A pump located in the inner chamber pumps coolant fluid from the inner chamber into the outer chamber. The pumping action causes the coolant fluid to flow along a flow path up the outer chamber and over the barrier and back into the inner chamber as outer chamber fills. A refrigeration means is located in the flow path for cooling the coolant fluid. The coolant fluid flows over a fluid conduit received in the housing. The fluid conduit is received in the inlet and exits the housing through the outlet for delivering the liquid from the container through the housing to the exterior of the housing. The invention provides a portable apparatus that provides a cool and non-foamed beverage from a beverage container to a dispensing tap.

### FIELD OF THE INVENTION

The present invention relates to apparatuses and processes for cooling beverages and more particularly to portable beverage coolers for delivering cold and non-foamed beverages.

### BACKGROUND OF THE INVENTION

There are numerous events and activities where one desires to enjoy cool beverages. However, many such events and activities are located in places where there is no access to cool beverages chilled by traditionally means such as refrigerators. In particular, remote locations such as on the golf courses, sporting events, outdoor concerts and other outdoor activities do not facilitate the easy distribution of cool beverages. Easy distribution of cool beverages is also desirable at resorts, bars and restaurants. Most consumers at these activities desire cool beverages.

There have been attempts to use kegs or other such large vessels to distribute cool beverages at remote locations. However, it has proven to be difficult to cool large vessels so that the beverages are of an acceptable temperature. Further, portable containers are often subject to severe agitation when they are traveling over hilly or rough terrain such as golf courses. A combination of elevated temperature and agitation causes the beverages to form foam. If the beverage is beer, the beer which discharges from the container will be in the form of foam. This ruins the taste of the beverage and makes it impossible to pour the beer properly due to excess foaming.

Numerous means have been developed to provide such beverages. There exists in the prior art inventions which have a similar purpose as the subject invention. In particular, U.S. Pat. No. 4,225,059 describes a portable beverage cooler and dispenser. The apparatus includes an air cylinder for pressurizing beer kegs. The beer kegs are located in a housing. The beer kegs are connected to a coiled dispensing hose also located in the housing. The hose passes through ice located in ice chambers. This serves to cool the beer before it is dispensed through spigots at the top of the apparatus. In addition, U.S. Pat. No. 2,223,152 describes a stationary beer cooling device. The device is not pressurized. The device cools the beer by circulating it through a cooling coil which is immersed in an ice water bath. The cooling coil is protected by a perforated metal sleeve so as to permit an operator to agitate the ice bath with a stick or a rod. The drawback to both of these inventions is that they do not adequately cool and de-foam beer.

However, neither the cooling nor pressurization of the carbonated beverage alone is sufficient to satisfactorily reduce foam. The prior art does not describe an apparatus or process, of a portable nature, which provides for the dispensing of cooled, non-foamed carbonated beverages in an economical manner. Therefore there is a need for such apparatuses and processes.

There is a further need for an apparatus with efficient heat exchanging means that can provide cool and non-foamed beverage where the beverage has traveled in a dispensing line over a significant distance.

### SUMMARY OF THE INVENTION

The present invention provides an apparatus for dispensing a liquid stored in a container. The apparatus comprises a conduit for delivering a beverage from a container to the exterior of the housing and preferably to a dispensing means. The conduit passes through a housing that is adapted to hold and circulate a coolant liquid. A coolant fluid is circulated over the conduit. The housing is adapted to allow the coolant liquid to be re-circulated over a refrigeration means before being circulated once again over the conduit.

According to one aspect of the present invention, there is provided an apparatus for dispensing a liquid stored in a container comprising a housing defining an inner chamber for holding a quantity of a coolant fluid. The inner chamber has an opening for receiving the coolant fluid. The housing further defines an outer chamber surrounding the inner chamber. The inner and outer chambers are separated by a fluid impermeable barrier defining a sealed flow port. The outer chamber is positioned relative to the inner chamber to define a flow path between the outer chamber and the inner chamber whereby the coolant fluid flows over the barrier and into the opening of the inner chamber when the outer chamber is filled. A pump is coupled to the flow port for pumping the coolant fluid from the inner chamber to the outer chamber. A fluid conduit is received in the housing. The fluid conduit is received in the inlet and exits the housing through the outlet for delivering the liquid from the container through the housing to the exterior of the housing. A refrigeration means is located in the flow path.

According to another aspect of the present invention, there is provided a method of delivering a cool liquid from a container to a dispensing means comprising the following steps: providing a housing defining an inner chamber for holding a quantity of a coolant fluid, the inner chamber having an opening for receiving the coolant fluid, the housing further defining an outer chamber surrounding the inner chamber, the inner and outer chambers being separated by a fluid impermeable barrier defining a sealed flow port, the outer chamber being positioned relative to the inner chamber to define a flow path between the outer chamber and the inner chamber whereby the coolant fluid flows over the barrier and into the opening of the inner chamber when the outer chamber is filled; providing a refrigeration means located in the flow path; filling the inner and outer chambers with the coolant fluid; pumping the coolant fluid from the inner chamber through the flow port and through the flow path; providing a conduit for delivering the liquid from the container through the housing to the exterior of the housing, the conduit being received in the housing, the conduit communicating with the exterior of the housing through said inlet and said outlet; and delivering the fluid through the conduit from the container to the outlet.

### BRIEF DESCRIPTION OF THE DRAWINGS

In drawings which illustrate by way of example only a preferred embodiment of the invention,

FIG. 1 is a perspective view showing an apparatus of the present invention connected to a beverage container; and

FIG. 2 is a cross-sectional view of the apparatus of the present invention taken along the lines 2-2 of FIG. 1;

FIG. 3 is a fragmented view front elevation view of the apparatus of the present invention; and

FIG. 4 is a fragmented view front elevation view of an inner chamber of the present invention.

### DETAILED DESCRIPTION OF THE INVENTION

The present invention includes an apparatus 1 for delivering a liquid from a container 14 to a dispending tap 32 in a chilled and preferably non-foamed state. The liquid is preferably a carbonated beverage and most preferably beer. In the preferred embodiment of the present invention shown in FIG. 1, the beverage is beer and the container 14 is a beer keg.

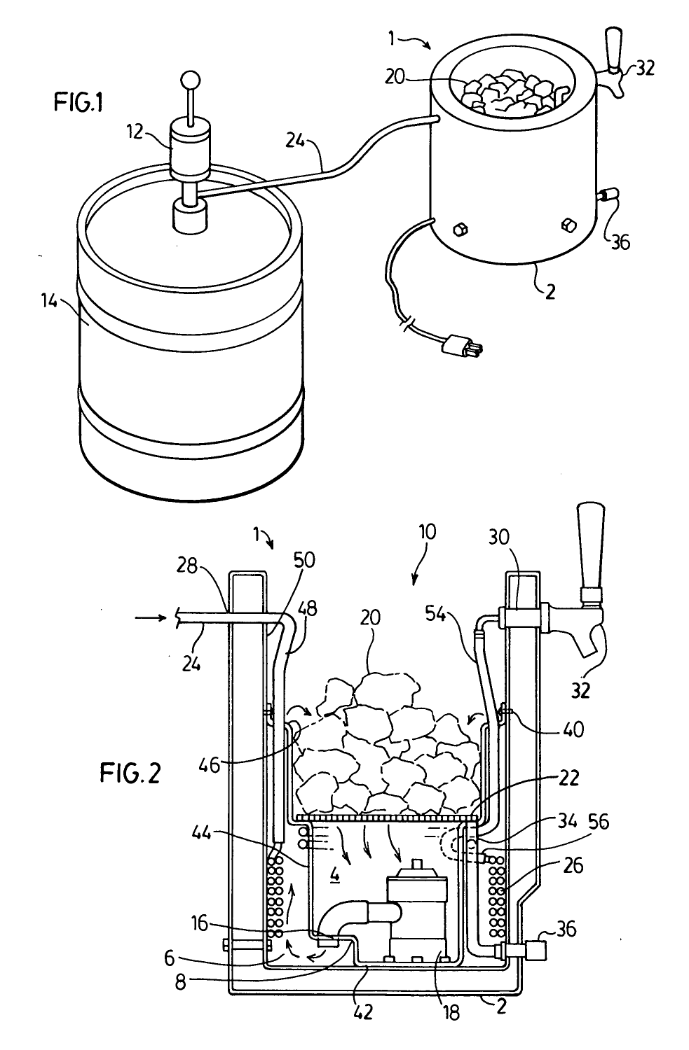

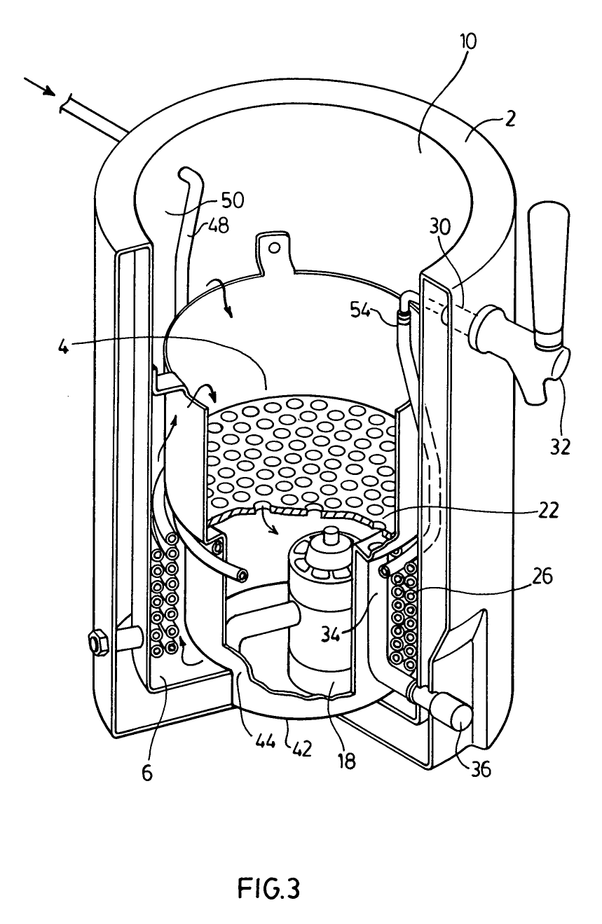

As shown in FIGS. 2 and 3, the apparatus 1 includes a housing 2. The housing is preferably an insulated tank. The housing 2 has an inner chamber 4. The inner chamber 4 has an open end 10 for receiving a coolant fluid to be held in the inner chamber 4. The inner chamber is preferably a tub that is secured in place in the housing by means of fasteners 40. The fasteners are preferably screws. The inner chamber has a base portion 42 and a sidewall 44. The sidewall 44 ends in a rim 46. The base 42 and sidewall 44 define a fluid impermeable barrier 8. A sealed flow port 16 is preferably formed in the barrier 8. A pump 18 is preferably located in the inner chamber 4. The pump 18 is coupled to the flow port 16 forming a seal therewith. The pump is preferably a centrifugal pump with an AC or DC motor. Other acceptable pumps are vane, gear or impeller pumps. In other embodiments, other means for circulating a fluid may be employed in place of a pump.

The housing 2 also has an outer chamber 6 located inside the housing 2. The outer chamber 6 surrounds the inner chamber 4. The outer chamber 6 is therefore referred to as being “outer” relative to the inner chamber 4. The outer chamber 6 is defined between the barrier 8 and an inner wall 50 of the housing 2.

The housing 2 preferably has an over fill tube 34 which maintains a maximum fluid level in the inner chamber. Preferably, the housing 2 has a drain tube 36 through which fluid may be drained from the housing.

A refrigeration means 20 is located in the housing 2. The refrigeration means 20 is preferably ice. Preferably, the ice is located in the inner chamber 4. Most preferably, a perforated plate 22 is located in the inner chamber for holding the ice and thereby protecting the pump 18.

A person skilled in the art will readily appreciate that many different refrigeration means known in the art can be employed for the purposes of the present invention. For example, glycol could be circulated through a heat exchange coil into the inner chamber to provide the refrigeration means. A heat exchange coil that is chilled by having cold glycol or direct expansion refrigerant flowing through it could be immersed in the cooling liquid found in chamber 4. Liquid in chamber 4 could pass over a cold plate chilled with liquid glycol.

A fluid conduit 24 is received through an inlet 28 formed in the housing 2. The conduit 24 passes through the housing 2 and exits the housing 2 through an outlet 30 formed in the housing 2. The conduit 24 is preferably attached to the container 14 at a first end of the conduit 24 and is preferably attached to a dispensing tap 32 at a second end of the conduit 24. The conduit 24 is preferably located in the outer chamber. As shown in FIG. 3 the conduit is located in the outer chamber and is preferably wound around an exterior of the inner chamber 6. In an alternate embodiment, the conduit may be located below the base 42 of the inner chamber 4. In other alternate embodiments, the conduit may pass through the inner chamber.

The conduit 24 preferably has a portion which is a heat exchange coil 26. The coil 26 is located in the housing such that it may be submerged in a coolant fluid, as discussed below. The heat exchange coil 26 may be constructed of any form of metal or steel tubing that permits heat exchange. Notable exceptions are copper and lead which can poison the beverage. The heat exchange coil is preferably constructed of stainless steel.

As best shown in FIG. 1, the conduit preferably has a first hose portion 48. The first hose portion is connected to the coil 26 at a connection 52. The conduit has a second hose portion 54. The second hose portion 54 is connected to the coil 26 at a connection 56. The coil and hose portions of the conduit 24 may be interconnected by a joint of conventional construction. The first hose portion 48 and the second hose portion 54 are preferably ¼ inch in diameter. The coil preferably has a ¼ inch diameter. The second hose portion preferably tapers to 3/16 inch diameter at dispensing tap 32, however the decrease may also be abrupt. The second hose portion 54 is preferably of a lesser diameter than the coil 26. As such, any carbonated beverage such as beer which is forced into the second hose portion 54 is subject to greater pressures than the beer was subject to in coil 26. As a result, any remaining separated gas is reintroduced into the beer.

In operation, the inner chamber 4 and the outer chamber 6 are filled with a coolant fluid such that the conduit and preferably the heat exchange coil 26 portion of the conduit 24 is submerged in the coolant fluid. In the preferred embodiment, the coolant fluid is water and is used in conjunction with ice as the refrigeration means. As other coolant fluids such as glycol may also be used in alternate embodiments.

In the preferred embodiment, the pump 18 pumps the coolant fluid through the sealed flow port 16 into the outer chamber. As shown in FIG. 3, this creates a flow path of coolant fluid through the outer chamber between the inner wall 50 of the housing and the barrier 8 such that the coolant fluid flows along the sidewall 44 of the inner chamber 4 and over the rim 46 into the opening 10 and over the refrigeration means 20 and then into the inner chamber 4. The coolant fluid is then re-circulated by the pump 18. It is therefore not essential that the refrigeration means be located in the inner chamber. The refrigeration means must merely be located in the flow path.

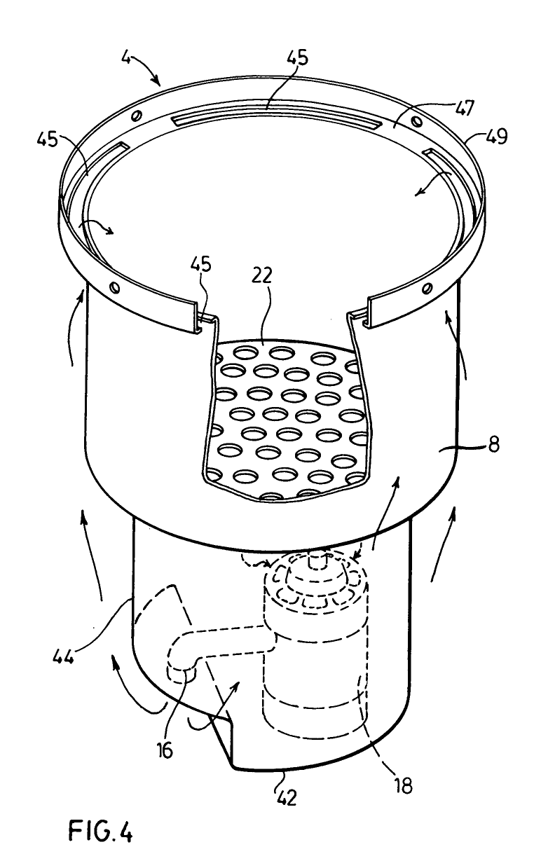

In an alternate embodiment of the present invention shown in FIG. 4, at least one slot 45 and preferably a plurality of slots 45 is preferably formed in a horizontal portion 47 of a flange 49 formed on the sidewall 44 so that the circulating coolant fluid can enter the inner chamber through the slots 45. In yet another alternate embodiment, the slots can be formed in the sidewall 44.

Beverage is transferred from the container 14 through the conduit 24 to the housing 2. Where the container is a beer keg, the beer is preferably pumped into the conduit by means of a hand pump 12. The beverage moves through the conduit 24. Beverage moves through the heat exchange coil 26 that is submerged in the coolant fluid. The flow of coolant fluid over the conduit and preferably over the coil 26 promotes maximum heat exchange. As the beverage moves from the coil 26 through connection 56 to the second hose portion 54, in the case of a carbonated beverage, foaming is preferably inhibited by the constriction in the conduit. The beverage then flows through the second end of the conduit to dispensing tap 32.

Various embodiments of the present invention having been thus described in detail by way of example, it will be apparent to those skilled in the art that variations and modifications may be made without departing from the invention. The invention includes all such variations and modifications as fall within the scope of the appended claims.

We claim:

1. An apparatus for dispensing a liquid stored in a container comprising:
a housing defining an inner chamber for holding a quantity of a coolant fluid, the inner chamber having an opening for receiving the coolant fluid, the housing further defining an outer chamber surrounding the inner chamber, the inner and outer chambers being separated by a fluid impermeable barrier defining a sealed flow port, the outer chamber being positioned relative to the inner chamber to define a flow path between the outer chamber and the inner chamber whereby the coolant fluid flows over the barrier and into the opening of the inner chamber when the outer chamber is filled;
a pump coupled to the flow port for pumping the coolant fluid from the inner chamber to the outer chamber;
a refrigeration means located in the flow path; and
a fluid conduit received in the housing, the fluid conduit being received in the inlet and exiting the housing through the outlet for delivering the liquid from the container through the housing to the exterior of the housing.

2. An apparatus according to claim 1 wherein at least a portion of the conduit is a heat exchange coil.

3. An apparatus according to claim 2 wherein the heat exchange coil is composed of a material selected from the group consisting of stainless steel, aluminum, copper and nickel.

4. An apparatus according to claim 1 wherein the coolant fluid is water or glycol.

5. An apparatus according to claim 4 wherein the coolant fluid is water.

6. An apparatus according to claim 1 wherein the refrigeration means is selected from the group consisting of ice, direct expansion refrigeration coil, liquid cooled coil heat exchanger, liquid cooled cold plate heat exchanger and thermoelectric cooling.

7. An apparatus according to claim 6 wherein the refrigeration means is ice.

8. An apparatus according to claim 1 wherein the conduit passes through the outer chamber.

9. An apparatus according to claim 1 wherein the inner chamber defines a slot for receiving coolant fluid from the outer chamber.

10. An apparatus according to claim 1 wherein the conduit has a restriction in its inner diameter.

11. An apparatus according to claim 7 wherein a perforated plate is located above the opening of the inner chamber to support the ice.

12. A method of delivering a cool liquid from a container to a dispensing means comprising the following steps:
providing a housing defining an inner chamber for holding a quantity of a coolant fluid, the inner chamber having an opening for receiving the coolant fluid, the housing further defining an outer chamber surrounding the inner chamber, the inner and outer chambers being separated by a fluid impermeable barrier defining a sealed flow port, the outer chamber being positioned relative to the inner chamber to define a flow path between the outer chamber and the inner chamber whereby the coolant fluid flows over the barrier and into the opening of the inner chamber when the outer chamber is filled;
providing a refrigeration means located in the flow path;
filling the inner and outer chambers with the coolant fluid;
pumping the coolant fluid from the inner chamber through the flow port and through the flow path;
providing a conduit for delivering the liquid from the container through the housing to the exterior of the housing, the conduit being received in the housing, the conduit communicating with the exterior of the housing through said inlet and said outlet; and
delivering the fluid through the conduit from the container to the outlet.

13. A method according to claim 12 wherein a perforated plate is located above the opening of the inner chamber to support the refrigeration means.

14. A method according to claim 12 wherein at least a portion of the conduit is a heat exchange coil.

15. A method according to claim 14 wherein the heat exchange coil is composed of a material selected from the group consisting of stainless steel, steel, copper, aluminum, monel and nickel.

16. A method according to claim 12 wherein the coolant fluid is selected from the group consisting of water, glycol, and potassium formate.

17. A method according to claim 16 wherein the coolant fluid is water.

18. A method according to claim 12 wherein the refrigeration means is selected from the group consisting of ice, direct expansion refrigeration coil, liquid cooled coil heat exchanger, liquid cooled cold plate heat exchanger and thermoelectric cooling.

19. A method according to claim 13 wherein the refrigeration means is ice.

20. A method according to claim 12 wherein the step of pumping is carried by a submersible pump located in the inner chamber.
